(19) United States
(12) Patent Application Publication
(10) Pub. No.: US 2015/0206196 A1
(43) Pub. Date: Jul. 23, 2015

(54) MODIFYING ADVERTISMENT BID AMOUNTS BASED ON A TARGET AVERAGE PRICE PAID FOR ADVERTISEMENT PRESENTATION

(71) Applicant: Facebook, Inc., Menlo Park, CA (US)

(72) Inventors: Chinmay Deepak Karande, Mountain View, CA (US); Mark Rabkin, Palo Alto, CA (US); Max Christian Eulenstein, San Francisco, CA (US)

(73) Assignee: Facebook, Inc., Menlo Park, CA (US)

(21) Appl. No.: 14/160,510

(22) Filed: Jan. 21, 2014

(51) Int. Cl. G06Q 30/02

(52) U.S. Cl. CPC G06Q 30/0275

(57) ABSTRACT

A social networking system modifies a bid amount associated with advertisements in an advertising campaign based on a target average price paid associated with the advertising campaign. A bid amount is determined from the target average price paid and associated with advertisements from the advertising campaigns in various advertisement selection processes. From advertisement selection processes in which an advertisement from the advertising campaign was selected, an average amount charged to the advertiser is determined. Based on the target average price paid and the average amount charged to the advertiser, the bid amount is modified. In subsequent advertisement selection processes, the modified bid amount is associated with advertisements from the advertising campaign.

### BACKGROUND

This disclosure generally relates to advertisement pricing, and more specifically to adjusting an advertisement's bid amount to achieve a target average price paid by the advertiser for an ad campaign.

Advertisers may have certain goals when planning a new advertising campaign (“advertising campaign”). For example, an advertiser has a goal for the number of times an advertisement is presented to users of an online system (i.e., the number of “impressions” of the advertisement), the number of different online system users presented with an advertisement (i.e., the “reach” of the advertisement), and/or a duration during which the advertisement is presented. Conventionally, an advertiser may specify certain attributes of an advertising campaign or advertisements in an advertising campaign when specifying the advertising campaign.

Conventionally, an advertiser associates a bid amount with advertisements in an advertising campaign specifying a maximum amount of compensation the advertiser provides to an online system presenting advertisements for a conversion event associated with an advertisement in the advertising campaign. However, when advertisements are selected for presentation by an online system, the amount charged to the advertiser is often less than the bid amount. For example, an online system charges an advertiser an amount based on an advertisement that was not selected for presentation. This results in an advertiser being charged a variable amount each time an advertisement from an advertising campaign is selected for presentation. This variation in amount charged to an advertiser may result in inefficient use of an advertiser's budget for presenting advertisements in an advertising campaign.

### SUMMARY

A social networking system receives an advertising campaign from an advertiser. The advertising campaign specifies a target average price paid by the advertiser and includes information describing one or more advertisements for presentation to social networking system users. The target average price paid specifies an amount of compensation the advertiser desires to pay the social networking system per action (i.e., presentation of an advertisement in the advertising campaign or other conversion event associated with an advertisement in the advertising campaign).

Based on the target average price paid, the social networking system determines a bid amount associated with one or more advertisements in the advertising campaign based on a target average price paid specified by the advertising campaign. For example, the social networking system associates the target average price paid with advertisements in the advertising campaign. When the social networking system identifies opportunities to present advertisements to users, one or more advertisements from the advertising campaign are included in processes selecting advertisements for presentation to various users and associated with the determined bid amount. For example, an advertisement from the advertising campaign associated with targeting criteria satisfied by a user is included in a process to select an advertisement for presentation to the user, with the determined bid amount associated with the advertisement from the advertising campaign in the process. Advertisements may be selected for presentation based on the bid amounts associated with the advertisements. For example, an advertisement associated with a maximum bid amount included in the process is selected for presentation.

When an advertisement is selected for presentation via a process selecting one or more advertisements (a “selection process”), an advertiser associated with the advertisement is charged an amount based on bid amounts associated with various advertisements in the selection process. For example, an advertiser associated with a selected advertisement is charged an amount based on a bid amount of an advertisement having a bid amount lower than the bid amount associated with the selected advertisement. An average amount charged to the advertiser associated with the advertising campaign is determined based on the amounts charged to the advertiser in various selection processes in which an advertisement from the advertising campaign was selected.

Based on the average amount charged to the advertiser associated with advertising campaign and the target average price paid, the determined bid amount associated with advertisements included in the advertising campaign is modified. For example, the determined bid amount is increased if the average amount charged to the advertiser is less than the target average price paid and the determined bid amount is decreased if the average amount charged to the advertiser is greater than the target average price paid. The modified bid amount is then associated with advertisements from the advertising campaign in subsequent selection processes, with a modified bid amount determined based on differences between the modified initial bid amount and the amounts charged to the advertiser when advertisements are selected. This allows the bid amount associated with advertisements in the advertising campaign to be modified based on the results of selection processes so the amount charged to the advertiser approaches the target average price paid as advertisements from the advertising campaign are presented.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 illustrates a flow diagram of a method for determining a bid amount of an advertisement based on a target average price paid, in accordance with an embodiment.

FIG. 4 illustrates an example of modifying an advertisement's bid amount based on a target average price paid, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

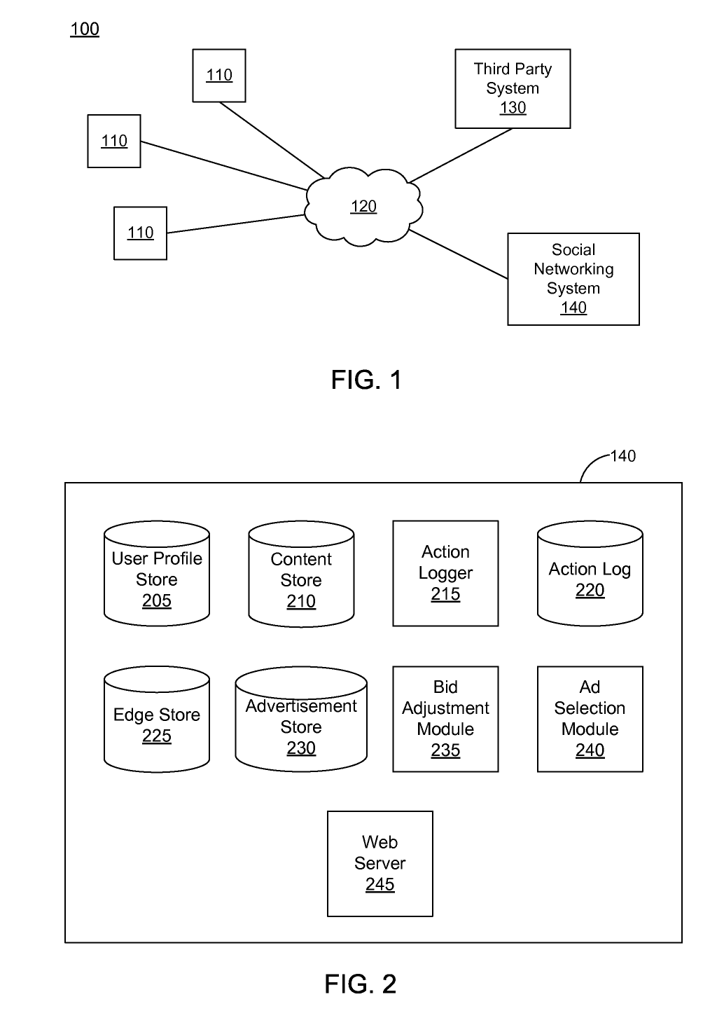

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an advertisement (“ad”) store 230, a bid adjustment module 235, an ad selection module 240, and a web server 245. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The advertisement store 230 stores information describing advertisement (“ad”) campaigns received from one or more advertisers. Each advertising campaign includes one or more advertisements described by ad requests, so the advertisement score 230 also includes information describing various advertisement requests comprising advertising campaigns. An advertising campaign is associated with a budget and a target average price paid. Additionally, an advertising campaign may be associated with one or more objectives and a duration.

A target average price paid represents an amount of compensation an advertiser desires to pay the social networking system 140 per action associated with advertisements in the advertising campaign. For example, the target average price paid specifies an average amount of compensation the advertiser seeks to provide the social networking system 140 for each presentation of an advertisement in the advertisement campaign to a social networking system user (an “impression”) or for each conversion event associated with an advertisement from the advertising campaign presented to a social networking system user (e.g., an interaction with an advertisement, an interaction with an object associated with an advertisement, etc.).

The budget represents a total amount of revenue an advertiser has allocated to compensate the social networking system 130 for presenting advertisements in an advertising campaign. An amount is deducted from the budget each time an advertisement from an advertising campaign is presented and an action associated with the advertisement by an advertiser occurs (e.g., an impression of an advertisement, a conversion event associated with the advertisement). When the budget is exhausted, the social networking system 140 ceases presentation of advertisements from an advertising campaign associated with the budget. In various embodiments, the bid adjustment module 235, further described below, determines a bid amount associated with various advertisements in an advertising campaign based on the budget and the target average price paid.

An objective associated with an advertising campaign describes one or more goals for actions associated with the advertising campaign. For example, an objective specifies a total number of impressions of advertisements in the advertising campaign to social networking system users (an “impression objective”), specifies a total number of unique social networking system users to be presented with at least one advertisement from the advertising campaign (a “reach objective”), a number of times an advertisement from the advertising campaign is presented to a social networking system user (a “frequency objective”), or any other suitable criteria. Additionally, the duration associated with the advertising campaign specifies a time interval during which advertisements from the advertising campaign are presented to social networking system users. For example, if the duration of an advertising campaign is 30 days, advertisements included in the advertising campaign are presented to social networking system users for 30 days after the advertising campaign is provide to the social networking system 140 or until the budget is exhausted. In some embodiments, the advertiser specifies a start date for the advertising campaign, so the duration is measured from the specified start date.

An advertising campaign includes one or more advertisement (“ad”) requests that each describe advertisements for presentation to one or more social networking system users. An ad request includes advertisement content, which is text, image, audio, video, or any other suitable data presented to a user. In various embodiments, the advertisement content is associated with a network address specifying a landing page, or other destination, to which a user is directed when the advertisement is accessed. A bid amount is also associated with each ad request and represents a maximum amount of compensation, such as monetary compensation, an advertiser associated with the advertising request provides the social networking system 140 in exchange for presentation of the advertisement described by the ad request. An ad request also associates a bid amount with an advertisement. An expected value to the social networking system 140 of presenting an advertisement may be determined based on the bid amount associated with a corresponding ad request or based on the bid amount and a likelihood of a user interacting with the advertisement if it is presented to the user. Examples of actions associated with a bid amount include presenting an advertisement to a user, receiving a user interaction with the advertisement, receiving a user interaction with an object associated with the advertisement, or any other suitable condition. For example, the bid amount specifies a monetary amount that the social networking system 140 receives from the advertiser if a user interacts with the advertisement is displayed and the expected value is determined by multiplying the bid amount by a probability of the user interacting with the advertisement. While an advertiser may associate a bid amount with an ad request, a bid amount may be determined for an ad request based on a target average price paid associated with an advertising campaign including the ad request, as further described below.

Additionally, an ad request may include one or more targeting criteria specified by the advertiser. Targeting criteria included in an ad request specify one or more characteristics of users eligible to be presented with advertisement content associated with the ad request. For example, targeting criteria are used to identify users having user profile information, edges or actions satisfying at least one of the targeting criteria. Hence, targeting criteria allow an advertiser to identify users having specific characteristics, simplifying subsequent distribution of ad content to different users. Additionally, targeting criteria may be associated with an advertising campaign as a whole, so multiple advertisements in the advertising campaign are eligible to users having characteristics satisfying one or more of the targeting criteria associated with the advertising campaign.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with ad content in an ad request that includes the targeting criteria. As another example, targeting criteria identifies users having a connection to another user or object or having a particular type of connection to another user or object.

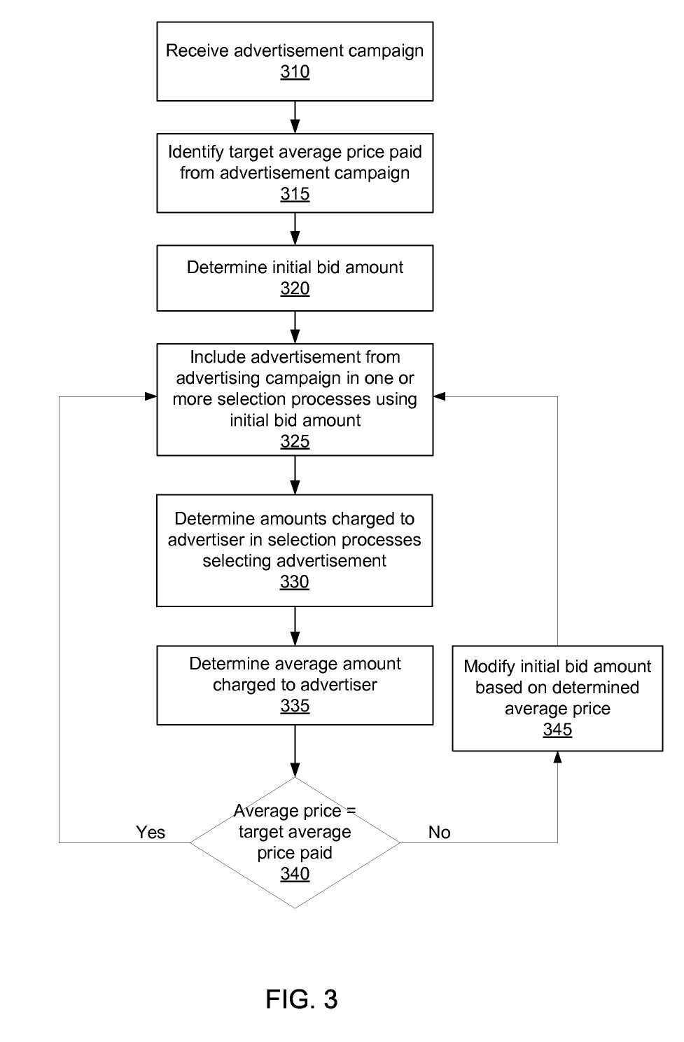

The bid adjustment module 235 determines a bid amount associated with one or more advertisements described by ad requests in an advertising campaign based on a target average price paid specified by the advertising campaign. As further described below in conjunction with FIG. 3, the bid adjustment module 235 specifies an initial bid amount for advertisements in an advertising campaign based on the advertising campaign's target average price paid. Advertisements from the advertising campaign are included in processes selecting advertisements for presentation to social networking system users using the initial bid amount. Based on a difference between the target average price paid and the amounts charged to the advertiser when advertisements from the ad campaign are selected for presentation using the initial bid amount, the bid adjustment module 235 modifies the initial bid amount. For example, the initial bid amount is increased if the amounts charged to the advertiser are less than the target average price paid and the initial bid amount is decreased if the amounts charged to the advertiser are greater than the target average price paid. The modified initial bid amount is then associated with advertisements from the advertising campaign in subsequent selection processes, with a modified bid amount determined based on differences between the modified initial bid amount and the amounts charged to the advertiser when advertisements are selected. Because the price paid by the advertiser is not the bid amount, but is an amount determined based on the bid amounts of other advertisements included in a selection process, modifying the bid amount affects the selection processes in which an advertisement from the advertising campaign is selected; the bid amounts of other advertisements in these selection processes in turn modify the amount paid by the advertiser to the social networking system 140. Modification of bid amounts based on the target average price paid is further described below in conjunction with FIG. 3.

The advertisement (“ad”) selection module 240 receives ad requests describing advertisements included in various advertising campaigns and selects one or more advertisements for presentation to a social networking system user. In some embodiments, the ad selection module 240 determines an expected value associated with each advertisement based at least in part on the bid amounts associated with each advertisement. The advertisements are ranked based in part on their associated expected values, and the ad selection module 240 selects advertisements having at least a threshold position in the ranking or having at least a threshold expected value for presentation to a user. An advertiser associated with a selected advertisement is charged an amount based at least in part on one or more bid amounts associated with advertisements that are not selected; for example an advertiser associated with a selected advertisement is charged an amount that is a specified amount greater than a highest bid amount associated with an unselected advertisement. However, other suitable methods may be used to determine an amount charged to an advertiser based on bid amounts associated with advertisements. In some embodiments, the ad selection module 240 uses an auction based on advertisements' bid amounts to select advertisements. Hence, the social networking system 140 charges an advertiser an amount less than or equal to the bid amount associated with a selected advertisement, making the bid amount the maximum amount an advertiser compensates the social networking system 140 if an advertisement is presented or if an interaction with a presented advertisement occurs.

Information describing selected advertisements may be maintained by the ad selection module 240. For example, an amount charged an advertiser associated with a selected advertisement is stored. Bid amounts associated with advertisements under consideration for selection may also be stored. Additional information describing a user presented with a selected advertisement, such as characteristics associated with the user, or describing a time when an advertisement was selected.

The web server 245 links the social networking system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the social networking system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

Modifying Advertisement Bid Amount to Satisfy a Target average price paid

FIG. 3 illustrates a flowchart of one embodiment of a method for determining a bid amount for an advertisement based on a target average price paid. In various embodiments, the method may include different and/or additional steps than those described in conjunction with FIG. 3. Additionally, in some embodiments the steps of the method may be performed in different orders than those described in conjunction with FIG. 3.

The social networking system 140 receives 310 an advertising campaign including one or more advertisements for presentation to social networking system users and identifies 315 a target average price paid from the received advertising campaign. As described above in conjunction with FIG. 2, the target average price paid specifies an average amount of compensation an advertiser desires to provide the social networking system 140 per action associated with advertisements in the advertising campaign. For example, the target average price paid specifies an amount of compensation for the advertiser to provide the social networking system 140 for each impression of an advertisement in the advertising campaign or for each conversion event associated with an advertisement in the advertising campaign.

Based on the target average price paid identified 315 from the advertising campaign, the social networking system determines 320 an initial bid amount associated with advertisements in the advertising campaign. The initial bid amount specifies an amount the social networking system 140 associated with advertisements from the advertising campaign when selecting advertisements for presentation to social networking system users. In one embodiment, the initial bid amount is determined 320 to be the target average price paid. Alternatively, the initial bid amount is determined 320 to be an amount that is within a threshold value of the target average price paid; for example, the initial bid amount is determined 320 to be an amount that is 5%, or another suitable percentage, greater than the target average price paid because the amount charged to the advertiser if an advertisement from the advertising campaign is selected has at least a threshold likelihood of being less than the target average price paid.

When an opportunity to present one or more advertisements to a social networking system user is identified, the social networking system 140 includes 325 one or more advertisements from the advertising campaign in a selection process for selecting advertisements to present to the user. The advertisement from the advertising campaign is included 325 in the selection process and associated with the determined initial bid amount. For example, the advertisement from the advertising campaign and the determined initial bid amount are included 325 in an auction including advertisements from various advertising campaigns associated with corresponding bid amounts. The advertisement may be included 325 in multiple selection processes for presenting an advertisement to various social networking system users.

Amounts charged to an advertiser associated with the advertising campaign are determined 330 from selection processes where the advertisement was selected. As described above in conjunction with FIG. 2, the amount charged to an advertiser when an advertisement is selected is based in part on the bid amounts associated with other advertisements in the selection process. For example, if the advertisement from the advertising campaign is selected, the social networking system 140 charges the advertiser an amount based on an advertisement in the selection process having a bid amount lower than the initial bid amount associated with the advertisement. The amount charged to the advertiser may be based on the bid amounts associated with multiple advertisements in the selection process in some embodiments.

An average amount charged to the advertiser is determined 335 if the advertisement from the advertising campaign was selected by multiple selection processes. The average amount charged to the advertiser is determined from a number of selection processes that selected the advertisement from the advertising campaign and the amounts charged to the advertiser from each of the selection processes that selected the advertisement. In one embodiment, the average amount charged to the advertiser is determined 335 at periodic time intervals. For example, the average amount charged to the advertiser is determined 335 based on a number of selection processes selecting the advertisement within a specified time interval (e.g., one day, two days) and the corresponding amounts charged to the advertiser by the selection processes. Alternatively, the average amount charged to the advertiser is determined 335 based on any suitable criteria, such as completion of a specified number of selection processes, selection of the advertisement in a specified number of selection processes.

The social networking system 140 determines 340 if the average amount charged to the advertiser equals, or is within a threshold amount of, the target average price paid. For example, the social networking system determines 340 if the average amount charged to the advertiser is within a threshold amount or percentage of the target average price paid. If the average amount charged to the advertiser equals, or is within a threshold amount of, the target average price paid, the initial bid amount is not modified, and the advertisement from the advertising campaign is included 325 in additional processes selecting advertisements using the initial bid amount. In various embodiments, the social networking system 140 may perform the determination at periodic time intervals (e.g., daily) or when one or more conditions are satisfied (e.g., completion of a specified number of processes selecting advertisements, selection of the advertisement in a threshold number of selection processes, etc.).

However, if the average amount charged to the advertiser does not equal the target average price paid or is not within a threshold amount of the target average price paid, the social networking system 140 modifies 345 the initial bid amount based on the average amount charged to the advertiser. In one embodiment, the initial bid amount is modified based on a difference between the average amount charged to the advertiser and the target average price paid. For example, if the difference indicates that the average amount charged to the advertiser exceeds the target average price paid, the initial bid amount is decreased; if the difference indicates the average amount charged to the advertiser is less than the target average price paid, the initial bid amount is increased. However, in other embodiments, any suitable metric based on the average amount charged to the advertiser and the target average price paid may be used to modify 345 the initial bid amount. The modified initial bid amount is associated with the advertisement, and the advertisement is included 325 in additional processes selecting advertisements using the modified initial bid amount. As the advertisement is selected in one or more selection processes, the average amount charged to the advertiser in processes where the advertisement is selected is determined 335 and compared to the target average price paid. This allows the modified bid amount to be further modified 345 based on differences between the average amount charged to the advertiser and the target average price paid as the average amount charged to the advertiser changes.

In some embodiments, the social networking system 140 may notify the advertiser that the initial bid amount is unable to be modified 345 so the average amount charged to the advertiser is within a threshold amount of the target bid amount or equals the target average price paid. For example, the social networking system 140 may determine that the amount charged to the advertiser when the advertisement is selected for presentation is below the target average price paid by at least a threshold amount or percentage, and that additional advertisements included in the selection process have bid amounts less than the target average price paid by greater than a maximum amount or percentage. In this scenario, the social networking system 140 may be unable to modify 345 the initial bid amount to achieve the target average price paid because of the bid amounts associated with additional advertisements in processes selecting advertisements. Hence, information about the bid amounts of additional advertisements included in selection processes as well as the target bid amount may be used to determine if the target average price paid is unable to be reached. The social networking system 140 may notify the advertiser that the target average price paid is unable to be achieved, and may also suggest alternative target average prices for the advertiser to pay based on the bid amounts associated with additional advertisements in processes selecting advertisements.

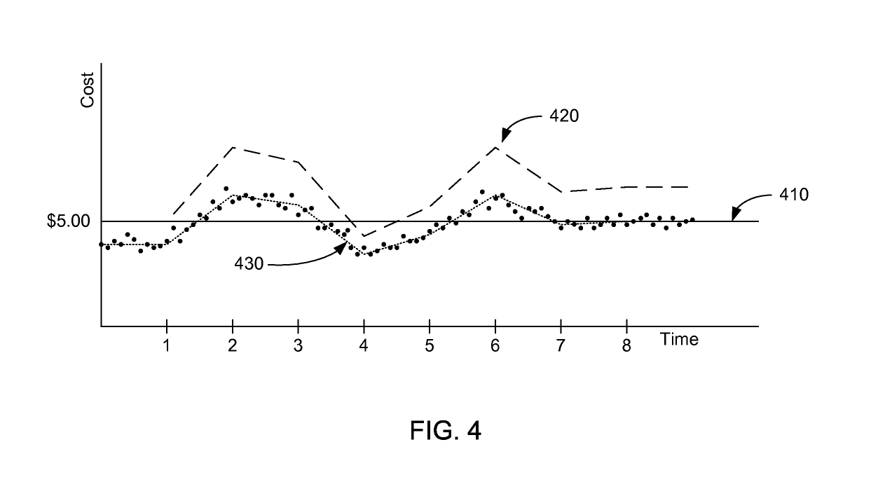

FIG. 4 is a graph illustrating an example of amounts charged to an advertiser for presentation of advertisements in an advertising campaign. In the example of FIG. 4, the advertiser specifies a target average price paid 410 of $5.00 per impression or per conversion event associated with advertisements in the advertising campaign. Initially, the social networking system 140 specifies a bid amount 420 associated with advertisements in the advertising campaign of $5.00, based on the target average price paid 410. Advertisements from the advertising campaign are included in selection processes for presenting advertisements to social networking system users based on the specified bid amount of $5.00. Amounts charged to the advertiser in selection processes where an advertisement from the advertising campaign is selected are identified and used to determine an average amount charged to the advertiser 430. For example, during a first day of the advertising campaign, the advertiser is charged an average amount of $4.00 per impression or per conversion event by selection processes that select an advertisement from the advertising campaign.

Because the average amount of $4.00 per impression or per conversion event charged to the advertiser during the first day of the advertising campaign is less than the target average price paid 410 of $5.00 per impression or per conversion event, the social networking system 140 increases the bid amount 420 associated with advertisements in the advertising campaign to $7.00. In the example of FIG. 4, this increase in bid amount causes advertisements from the advertising campaign to be selected by selection processes including advertisements associated with higher bid amounts, so the amount charged to the advertiser 430 increases to $6.00 per impression or per conversion event after the second day.

The increased amount charged to the advertiser 430 after the second day exceeds the target average price paid 410 of $5.00 per impression or per conversion event, so the social networking system decreases the bid amount 420 associated with advertisements from the advertising campaign. This reduces the bid amounts associated with other advertisements in selection processes that select an advertisement from the advertising campaign, which reduces the amount charged to the advertiser 430. As shown in FIG. 4, the bid amount 420 associated with advertisements from the advertising campaign is modified based on the average price charged to the advertiser 430 by selection processes occurring each day. Thus, over a duration of the advertising campaign, the amount charged to the advertiser 430 has an average amount within a threshold value of the specified bid amount 420.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an advertising campaign from an advertiser, the advertising campaign associated with a target average price paid by the advertiser and including one or more advertisements for presentation to users of an online system;
determining a bid amount associated with an advertisement from the advertising campaign based at least in part on the target average price paid;
including the advertisement and the bid amount in one or more processes selecting advertisements for presentation to one or more users of the online system;
determining an average price charged to the advertiser when the advertisement was selected for presentation to one or more users of the online system; and
modifying the bid amount based at least in part on the target average price paid and the average price charged to the advertiser.

2. The method of claim 1, further comprising:
including the advertisement and the modified bid amount in one or more additional processes selecting advertisements to present to one or more users of the online system;
determining a second average price charged to the advertiser when the advertisement was selected for presentation to one or more users of the online system; and
modifying the modified bid amount based at least in part on the modified bid amount and the second average price charged to the advertiser.

3. The method of claim 1, wherein determining the bid amount associated with an advertisement from the advertising campaign based at least in part on the target average price paid comprises:
setting the bid amount to the target average price paid.

4. The method of claim 1, wherein modifying the bid amount based the target average price paid and the average price charged to the advertiser comprises:
increasing the bid amount if the average price charged to the advertiser is less than the target average price paid; and
decreasing the initial bid amount if the average price charged to the advertiser is greater than the target average price paid.

5. The method of claim 1, wherein a process selecting advertisements to present to one or more users of the online system comprises an auction.

6. The method of claim 1, wherein determining the average price charged to the advertiser comprises:
identifying processes selecting advertisements in which the advertisement was selected responsive to a specified condition being satisfied; and
determining the average price charged to the advertiser based at least in part on a number of the identified processes selecting advertisements in which the advertisement was selected and on amounts charged to the advertiser in each of the identified processes selecting advertisement in which the advertisement was selected.

7. The method of claim 6, wherein the specified condition is completion of a time interval.

8. The method of claim 6, wherein the specified condition is selected from a group consisting of: completion of a specified number of processes selecting advertisements, selection of the advertisement in a threshold number of processes selecting advertisements, and any combination thereof.

9. A system comprising:
a processor; and
a computer-readable storage medium having instructions encoded thereon that, when executed by the processor, cause the processor to:
receive an advertising campaign from an advertiser, the advertising campaign associated with a target average price paid by the advertiser and including one or more advertisements for presentation to users of an online system;
determine a bid amount associated with an advertisement from the advertising campaign based at least in part on the target average price paid;
include the advertisement and the bid amount in one or more processes selecting advertisements to for presentation to one or more users of the online system;
determine an average price charged to the advertiser when the advertisement was selected for presentation to one or more users of the online system; and
modify the bid amount based at least in part on the target average price paid and the average price charged to the advertiser.

10. The system of claim 9, wherein the computer-readable storage medium further has instructions encoded thereon that, when executed by the processor, cause the processor to:
include the advertisement and the modified bid amount in one or more additional processes selecting advertisements to present to one or more users of the online system;
determine a second average price charged to the advertiser when the advertisement was selected for presentation to one or more users of the online system; and
modify the bid amount based at least in part on the modified bid amount and the second average price charged to the advertiser.

11. The system of claim 9, wherein determine the bid amount associated with the advertisement from the advertising campaign based at least in part on the target average price paid comprises:
set the bid amount to the target average price paid.

12. The system of claim 9, wherein modify the bid amount based on the target average price paid and the average price charged to the advertiser comprises:
increase the bid amount if the average price charged to the advertiser is less than the target average price paid; and
decrease the bid amount if the average price charged to the advertiser is greater than the target average price paid.

13. The system of claim 9, wherein a process selecting advertisements to present to one or more users of the online system comprises an auction.

14. The system of claim 9, wherein determine the average price charged to the advertiser comprises:
identify processes selecting advertisements in which the advertisement was selected responsive to a specified condition being satisfied; and
determine the average price charged to the advertiser based at least in part on a number of the identified processes selecting advertisements in which the advertisement was selected and on amounts charged to the advertiser in each of the identified processes selecting advertisement in which the advertisement was selected.

15. The system of claim 14, wherein the specified condition is completion of a time interval.

16. The system of claim 14, wherein the specified condition is selected from a group consisting of: completion of a specified number of processes selecting advertisements, selection of the advertisement in a threshold number of processes selecting advertisements, and any combination thereof.

17. A computer program product comprising a computer-readable storage medium having instructions encoded thereon that, when executed by a processor, cause the processor to:
receive an advertising campaign from an advertiser, the advertising campaign associated with a target average price paid by the advertiser and including one or more advertisements for presentation to users of an online system;
determine a bid amount associated with an advertisement from the advertising campaign based at least in part on the target average price paid;
include the advertisement and the bid amount in one or more processes selecting advertisements for presentation to one or more users of the online system;
determine an average price charged to the advertiser when the advertisement was selected for presentation to one or more users of the online system; and
modify the bid amount based at least in part on the target average price paid and the average price charged to the advertiser.

18. The computer program product of claim 17, wherein the computer-readable storage medium further has instructions encoded thereon that, when executed by the processor, cause the processor to:
include the advertisement and the modified bid amount in one or more additional processes selecting advertisements to present to one or more users of the online system;
determine a second average price charged to the advertiser when the advertisement was selected for presentation to one or more users of the online system; and
modify the bid amount based at least in part on the modified bid amount and the second average price charged to the advertiser.

19. The computer program product of claim 17, wherein modify the bid amount based on the target average price paid and the average price charged to the advertiser comprises:
increase the bid amount if the average price charged to the advertiser is less than the target average price paid; and
decrease the bid amount if the average price charged to the advertiser is greater than the target average price paid.

20. The computer program product of claim 17, wherein determine the average price charged to the advertiser comprises:
identify processes selecting advertisements in which the advertisement was selected responsive to a specified condition being satisfied; and
determine the average price charged to the advertiser based at least in part on a number of the identified processes selecting advertisements in which the advertisement was selected and on amounts charged to the advertiser in each of the identified processes selecting advertisement in which the advertisement was selected.
